(19) United States
(12) Patent Application Publication
(10) Pub. No.: US 2012/0025412 A1
(43) Pub. Date: Feb. 2, 2012

(54) INTEGRAL COOLING FIXTURE ADDENDUM FOR PANELS FORMED IN METAL FORMING PROCESS

(75) Inventors: Richard M. Kleber, Clarkston, MI (US); Gary A. Kruger, Troy, MI (US)

(73) Assignee: GM GLOBAL TECHNOLOGY OPERATIONS, INC., Detroit, MI (US)

(21) Appl. No.: 12/847,207

(22) Filed: Jul. 30, 2010

(51) Int. Cl. B29C 37/02

(52) U.S. Cl. 264/161

(57) ABSTRACT

One embodiment includes a method for forming panels in which a particular shaping of the addendum contours of the formed panel to provide the functionality of the cooling fixture.

### TECHNICAL FIELD

The field to which the disclosure generally relates includes metal forming processes, and more particularly to an integral cooling fixture addendum for a panel formed in a metal forming process.

### BACKGROUND

In high temperature metal forming processes such as quick plastic forming (“QPF”) and super plastic forming (“SPF”), metal sheets are formed into product shapes in high temperature forming tools. The formed sheets are removed from the forming tools and placed on a cooling fixture by a robot or dedicated gantry for the initial portion of the time that it takes for the panel to return to room temperature. The formed panel is malleable and easily distorted at its high temperature immediately after removal from the forming process. The cooling fixture is designed to ensure that the formed panel maintains its formed shape during the time that it cools from the high forming temperature to a temperature slightly higher than room temperature.

### SUMMARY OF EXEMPLARY EMBODIMENTS OF THE INVENTION

The exemplary embodiments use a particular shaping of the addendum contours of a formed panel to provide the functionality of a cooling fixture.

Other exemplary embodiments of the invention will become apparent from the detailed description provided hereinafter. It should be understood that the detailed description and specific examples, while disclosing exemplary embodiments of the invention, are intended for purposes of illustration only and are not intended to limit the scope of the invention.

### BRIEF DESCRIPTION OF THE DRAWINGS

Exemplary embodiments of the invention will become more fully understood from the detailed description and the accompanying drawings, wherein:

FIG. 1A illustrates an automotive lift gate panel coupled to a forming tool according to the prior art;

FIG. 1B is a cross-sectional view of the lift gate panel of FIG. 1A taken along line 1B-1B that has been coupled to a cooling fixture according to the prior art;

FIG. 2 is a logic flow diagram disclosing the methodology for forming a formed part in accordance with one exemplary embodiment;

FIG. 3A illustrates an automotive lift gate panel according to one exemplary embodiment coupled onto a flat surface for cooling;

FIG. 3B is a cross-sectional view of the lift gate panel of FIG. 3A taken along line 3A-3A;

FIG. 4A illustrates an automotive lift gate panel according to another exemplary embodiment coupled onto a flat surface for cooling; and

FIG. 4B is a cross-sectional view of the lift gate panel of FIG. 4A taken along line 4A-4A.

### DETAILED DESCRIPTION OF EXEMPLARY EMBODIMENTS

The following description of the embodiment(s) is merely exemplary (illustrative) in nature and is in no way intended to limit the invention, its application, or uses. Thus, the following description describes a lift gate panel as one exemplary example of a formed metal sheet that utilizes the novel principles described herein.

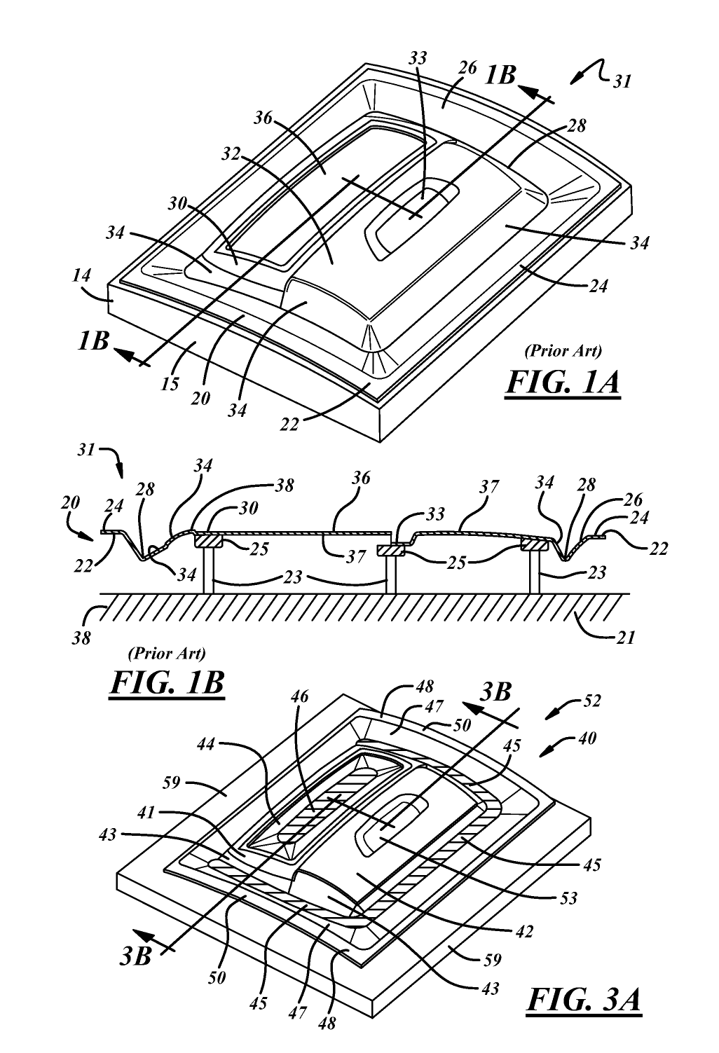

FIG. 1A shows an automotive lift gate panel 20 after forming on a high temperature forming tool, here a typical quick plastic forming (QPF) tool 14, in which the panel 20 has been formed downward over a male product definition 15. The perimeter area 22 of the formed panel 20 is an addendum portion having an addendum surface 24 that follows the seal bead area of the forming tool.

An addendum portion refers to any portion on a molded part (i.e. part formed on the high temperature forming tool) that does not form a portion of the finished molded part after trimming. In other words, the addendum portion is a portion of the molded part that is removed by trimming. An addendum surface, by implication, is the surface of the addendum portion that is also removed.

Referring back to FIG. 1A, the panel 20 surfaces transition downward from the perimeter addendum surface 24 along a transition area 26 to form a low area or trough 28 around a window frame portion 30 and a license plate portion 32 including a license plate pocket 33, with the inner transitional surfaces 34 defining another addendum surface from the trough 28 to the window frame portion 30 and the license plate portion 32. Internal to the window frame portion 30 is another section of window addendum material 36 that is typically left in a simple shape that would follow the gradual contours of the surrounding window opening of the window frame portion 30.

FIG. 1B shows a cross section of the formed panel 20 removed from the forming tool 14 (FIG. 1A) and placed on a cooling fixture 38 in accordance with a conventional method for cooling the formed panel 20. The cooling fixture 38 includes a base plate 21 having one or more stands 23 extending therefrom each including a cooling fixture pad 25. The cooling fixture 38 is designed to ensure that the formed panel 20 maintains its formed shape during the time that it cools from the high forming temperature to a temperature wherein the formed part is not easily distorted. Such distortion can occur in many different ways. First, the panel 20 may contract as it cools. If the panel 20 is overly constricted from movement, panel distortion may occur. In addition, if large areas of the panel 20 are not properly supported, the effects of gravity can distort the panel 20 at high temperatures. Further, high gravitational (“G”) forces from accelerated movement or impact during high temperature removal from the forming tool and placement onto the cooling fixture 38 may also result in panel distortion.

As shown in FIG. 1B, the cooling fixture pads 25 therefore contacts the formed panel 20 along portions of the formed panel 20 wherein shape stiffness at elevated temperatures is insufficient to allow the formed part to maintain its shape against the forces of gravity. As shown herein, the formed panel 20 therefore contacts the cooling fixture pads 25 along a portion of its bottom surface 37. In the embodiment shown in FIG. 1B, the cooling fixture pads 25 contacts the bottom surface 37 along the window frame portion 30 and the license plate portion 33. However, in other alternative embodiments, the cooling fixture pads 25 could contact the bottom surface 37 of the panel 20 at alternative locations such that the panel portion cools substantially or completely without distortion.

After the panel 20 cools, post-formation processing may be performed to remove the addendum surfaces constituting the perimeter addendum surface 24, the transition area 26, the inner transitional area 34 and the window addendum area 36. To accomplish this, first, the molded panel 20 is removed from the cooling fixture 40. Next, the perimeter addendum surface 24, the transition area 26, the inner transitional area 34 and the window addendum area 36 are trimmed with dies in a stamping press, or alternatively trimmed with a laser head on a robotic arm, depending upon the complexity of the trimming desired. The remaining portions of the molded part after trimming in general define the panel portion and herein define the lift gate 31 that may be further post-processed and eventually coupled to the rear of an automobile.

The exemplary embodiments described herein modify the shaping of the addendum contours of the formed panel to provide the functionality of the cooling fixture as the formed panel is placed on any flat, level surface. With proper design of this concept, the high temperature formed panels may be placed directly on the transfer conveyor which typically is a continuous flat surface expanding the length and width of the formed panel and allowed to cool without the need for a cooling fixture. In addition, the exemplary embodiments may allow smaller blank sizes (i.e. parts utilizing less addendum material that is subsequently removed) and hence better material utilization.

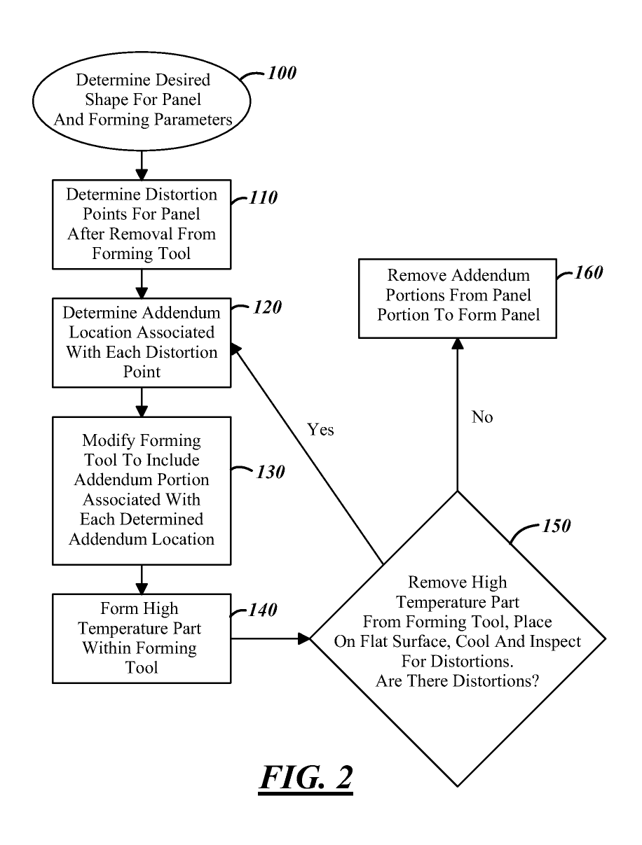

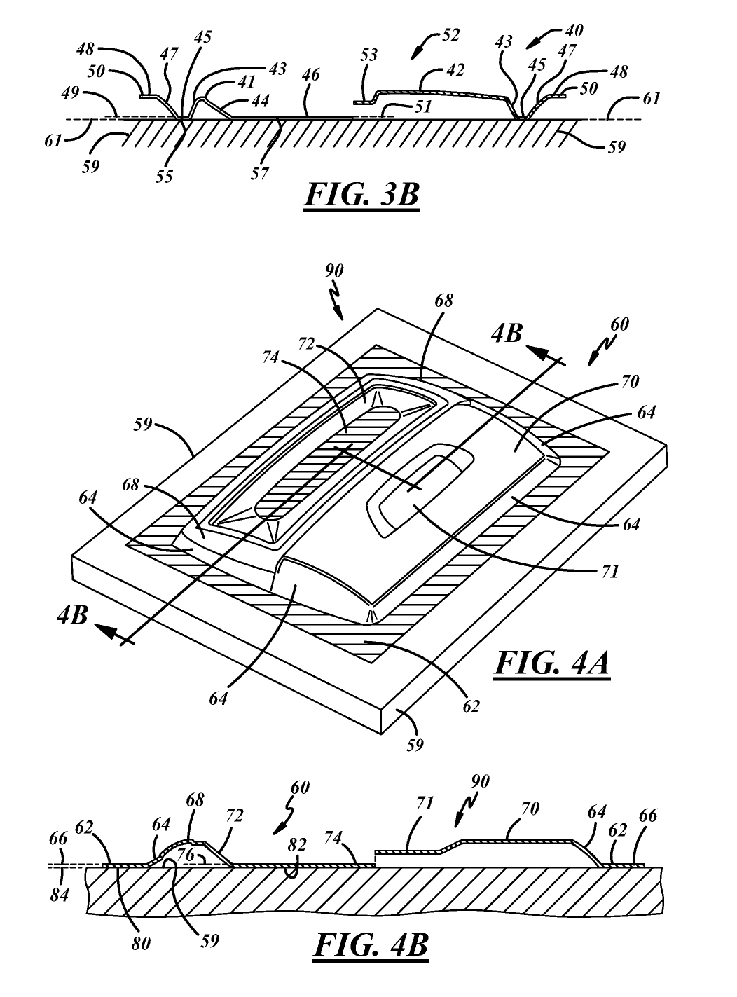

Referring now to FIG. 2, a logic flow diagram for forming a shaped metal panel according to one exemplary method, as well as two separate exemplary embodiments illustrating lift gate panels formed in accordance with the method of FIG. 2, as shown in FIGS. 3A-B and 4A-B, are illustrated.

Referring first to FIG. 2, and beginning with Step 100, an overall shape for the panel to be formed, as well as a determination of the materials used to form the panel, as well as a determination of the high temperature forming tools and molding parameters used to form the panel, may be first determined. Two conventional high temperature forming tools that may be used by the exemplary embodiments herein to form a high temperature panel are the so-called quick plastic forming tool, or QPF tool (such as 14 shown in FIG. 1A), and the superplastic forming tool, or SPF tool (not shown).

Quick plastic forming generally represents a process in which a relatively thin sheet metal workpiece is forced into conformance with a forming surface of a forming tool by a pressurized gas. Suitable sheet metal workpieces utilized in such a hot blow forming process are generally only about a millimeter to a few millimeters in thickness and are composed of materials capable of undergoing high deformation (sometimes superplastic deformation) such as aluminum and magnesium alloys.

Superplastic forming typically includes the steps of heating a sheet of material to a point in which superplastic deformation is possible, clamping the material within a sealed die and then using gas pressure to force the material to stretch and take the shape of a forming surface located in the die cavity. Controlling the gas pressure during the forming process controls the deformation rate of the material and maintains superplasticity at the elevated temperature.

Next, in Step 110, a determination may be made as to the location of any distortion points after formation of the panel and after removal from the forming tool are determined. This may be accomplished by first forming a panel in a high temperature forming tool, removing the panel from the forming tool, and placing the panel onto a flat and level surface. The panel may then be allowed to cool a temperature below its deformation point (i.e. the deformation point is where the panel is easily distorted due to panel constriction, the forces of gravity or during tool extraction) of the material formed. The cooled panel may then be inspected to determine any points of distortion.

In Step 120, an addendum location may be determined that is associated with each of the points of distortion. The addendum location may be a location wherein the introduction of addendum material is thought to prevent the localized deformation of the panel during the cooling process after high temperature formation.

In Step 130, the high temperature molding tool may be modified to include these addendum locations. For a QPF forming tool or SPF forming tool, the shape of the metal part to be formed with the respective tool may be modified by size or shape to include these one or more addendum portions.

In Step 140, a high temperature part may be formed within the high temperature forming tool, the high temperature part including the panel portion and the one or more addendum portions.

In Step 150, the high temperature part may then be cooled on a flat surface and visually inspected to determine whether any more distortion points in the panel portion are present. If no distortion points are present, proceed to Step 160, otherwise revert to Step 120 to determine one or more additional, or modified, addendum locations sufficient to substantially prevent distortion in the panel portion.

In Step 160, the addendum portions may be removed from the panel portions of the high temperature part by trimming or some other conventional process to form the panel. The panel portion, such as, but not limited to, a lift gate panel 31, 52 disclosed below in FIGS. 3A-B and 4A-B, may then be post-processed and used as a portion of a vehicle body.

Two exemplary embodiments of lift gate panels that utilize this concept, formed in a manner similar to the lift gate panel 20 of FIG. 1A, are illustrated below in FIGS. 3A-B and 4A-B.

FIG. 3A illustrates a lift gate panel 40 after forming on high temperature molding apparatus such as a QPF tool in accordance with one exemplary embodiment of the present invention in which the panel 40 may have also been formed downward over a male product definition. In FIG. 3A, the lift gate panel 40 has been removed and placed upon a flat surface 59. The perimeter area 48 of the formed panel 40 may be an addendum portion having an addendum surface 50 that follows the seal bead area of the forming tool. The addendum surface 50 of the panel 40 may transition downward from the perimeter area 48 through a transition area 47 to a low area or trough 45 that forms a plane (shown in FIG. 3B as 49). Inboard of the planar trough 45, the panel 40 may transition upward through a transition area 43 to the window frame portion 41 and to the license plate portion 42 including a license plate pocket 53. Internal to the window frame portion 41 may be a perimeter portion 44 and a window opening addendum 46. The perimeter portion 44 internal to the window frame portion 41 may transition downward to allow the center portion of the window opening addendum 46 to form a plane (shown in FIG. 3B as 51). The plane 51 internal to the window opening addendum 46 may be coincident with the plane 49 formed by the perimeter trough 45.

FIG. 3B show a cross section of the formed part 40 removed from the forming tool and placed on a flat surface 59 without the use of a cooling fixture. The formed part 40 may contact the flat surface 59 on the bottom surface 55 of the planar trough surface 45. In addition, the bottom surface 57 of the window opening addendum 46 may also contact the flat surface 59. The bottom surface 55 and the bottom surface 57 define a plane 61 therefore that may be parallel with planes 49 and 51, respectively.

FIG. 3B also shows that the addendum transition area 43 and the addendum perimeter portion 44 may support the window frame portion 41 and to the license plate portion 42 from the interface of the flat surface 59 and the bottom surfaces 55, 57, therein substantially preventing or minimizing distortion of the window frame portion 41 and license plate portion 42 as the formed part 40 cools.

After the formed part 40 is cooled on the flat surface 59 to a temperature by which the formed part is no longer significantly malleable, the addendum portions may be removed. In the exemplary embodiment provided in FIGS. 3A and 3B, a laser head on a robotic arm may be used to trim the transition area 43, the perimeter portion 44, the window opening addendum 46, the transition area 47, and the perimeter area 48. The remaining panel portions after trimming therein may define the lift gate 52 that may be further post-processed and eventually coupled to the rear of an automobile.

FIG. 4A illustrates an alternative configuration of a similar automotive lift gate formed panel 60 that may have been formed upward into a QPF tool having a female forming product definition (not shown) with a flat binder surface. Here, and in FIG. 4B, the panel 60 has been placed on a flat surface 59. This exemplary embodiment may allow for smaller formed panels 60 and hence better material utilization.

The formed panel 60 may include a perimeter addendum area 62 defining a planar surface (shown as 66 in FIG. 4B). The panel 60 may be continued inboard through a non-planer, transitional addendum portion 64 to a window frame portion 68 and to a license plate portion 70 having a license plate pocket 71. Internal to the window frame portion 68 may be a perimeter addendum portion 72 that transitions downward to a center addendum portion 74 which forms a plane (shown as 76 in FIG. 4B). The plane 76 may be coincident with the perimeter planar surface 66.

FIG. 4B shows a cross-section of the formed part 60 removed from the forming tool and placed onto the flat surface 59 without the use of a cooling fixture. The formed part 60 may contact the flat surface on the bottom surface 80 of the perimeter addendum area 62 and along the bottom surface 82 of the center addendum portion 74. The bottom surface 80 and the bottom surface 82 may define a plane 84 that may be parallel with planes 66 and 76, respectively.

FIG. 4B also shows that the transitional addendum portion 64 and the perimeter addendum portion 72 may support the window frame portion 68 and license plate portion 70 from the interface of the flat surface 59 and the bottom surfaces 80, 82 as the formed part 60 cools, therein substantially preventing or minimizing distortion of the window frame portion 68 and the license plate portion 70.

After the formed part 60 may be cooled on the flat surface 59, the addendum portions may be removed. In the exemplary embodiment provided in FIG. 3A, a laser head on a robotic arm may trim the perimeter addendum area 62, the transitional addendum portion 64, the perimeter the perimeter addendum portion 72 and the center addendum portion 74. The remaining portions after trimming may therefore define the lift gate 90 that may be further post-processed and eventually coupled to the rear of an automobile.

By utilizing concepts described herein, reduced investment costs may be realized, as the cost of cooling fixtures may be eliminated. Further, reduced costs may also be realized by removing the manpower machinery required to transfer a molded part such as a lift gate to and from the cooling fixture. In production situations, the flat surfaces 59 described in FIGS. 3B and 4B, respectively, may be the initial portions of transfer conveyors that transport the formed panel 40 or 60 for further processing, including transporting to a location wherein the addendum pieces may be trimmed to form the panels 52, 90, which may result in further costs savings.

While the above described concepts are directed to the formation of a lift gate panel, the concepts described herein may be utilized to form any type of panel formed in a high temperature forming tool that conventionally uses a cooling fixture with which to support the malleable metal part as it is cooled to its final shape. Also, additional features may be incorporated into a lift gate panel using the concepts described herein but not illustrated in FIGS. 1-4, including, for example, lift gate panels having lighting recesses.

The above description of embodiments of the invention is merely exemplary in nature and, thus, variations thereof are not to be regarded as a departure from the spirit and scope of the invention.

What is claimed is:

1. A method for forming a panel comprising:
providing a high temperature molding tool;
forming a high temperature part within said high temperature molding tool, said high temperature part including at least one addendum portion coupled to a panel portion;
removing said high temperature part from said high temperature molding tool;
placing said high temperature part on a flat surface;
cooling said high temperature part on said flat surface, wherein said at least one addendum portion aids in substantially preventing or minimizing distortion of said panel portion as said panel portion cools on said flat surface; and
removing said at least one addendum surface from said panel portion.

2. The method of claim 1, wherein placing said high temperature part on a flat surface comprises:
placing said high temperature part on said flat surface, wherein a portion of said at least one addendum portion contacts said flat surface and wherein said panel portion does not contact said flat surface.

3. The method of claim 1, wherein said at least one addendum portion comprises a perimeter addendum portion.

4. The method of claim 1, wherein said at least one addendum portion comprises a perimeter addendum portion and a center addendum portion, said perimeter portion being separated from said center addendum portion by said panel portion.

5. The method of claim 1, wherein said addendum portion comprises a center addendum portion contained within said panel portion.

6. The method of claim 4, wherein a portion of said perimeter addendum portion and a portion of said center addendum portion contacts said flat surface when said high temperature part is placed onto said flat surface.

7. The method of claim 1, wherein said flat surface is a portion of a transfer conveyor.

8. The method of claim 1, wherein said high temperature forming tool comprises a quick plastic forming tool.

9. The method of claim 1, wherein said high temperature forming tool comprises a superplastic forming tool.

10. An automotive lift gate panel formed according to the method of claim 1.

11. The method of claim 1, wherein forming a high temperature part within said high temperature molding tool comprises:
forming a high temperature part downward over a male product definition of said high temperature molding tool.

12. The method of claim 1, wherein forming a high temperature part within said high temperature molding tool comprises:
forming a high temperature part upward over a female product definition of said high temperature molding tool.

13. The method of claim 1, wherein removing said at least one addendum surface from said panel portion to form the panel comprises:
trimming said at least one addendum surface from said panel portion to form the panel using a laser head on a robotic arm.

14. A method for forming a panel in a high temperature forming tool without the need for a cooling fixture, the method comprising:
determining a shape for the panel;
determining each of said possible distortion points associated with cooling the panel on a flat surface;
determining a shape and size for at least one addendum portion to be formed as a portion of a high temperature part within a high temperature forming tool, said high temperature part also including a panel portion, where said at least one addendum portion substantially minimizes or eliminates each of said possible distortion points on said panel portion;
modifying the forming surface of said high temperature forming tool to accommodate said at least one addendum portion;
forming said high temperature part within said high temperature forming tool;
removing the high temperature part from said high temperature forming tool and placing the high temperature part on a flat surface;
cooling the high temperature part on said flat surface; and
removing said at least one addendum portion from said panel portion.

15. The method of claim 14 further comprising:
inspecting said cooled high temperature part to confirm that no distortions are present in said panel portion;

16. The method of claim 14, wherein said at least one addendum portion comprises a perimeter addendum portion.

17. The method of claim 14, wherein said at least one addendum portion comprises a perimeter addendum portion and a center addendum portion, said perimeter portion being separated from said center addendum portion by said panel portion.

18. The method of claim 14, wherein said addendum portion comprises a center addendum portion contained within said panel portion.

19. The method of claim 14, wherein a portion of said addendum portion contacts said flat surface when said high temperature part is placed onto said flat surface.

20. The method of claim 14, wherein said flat surface is a portion of a transfer conveyor.
